(19) United States
(12) Patent Application Publication
(10) Pub. No.: US 2026/0057344 A1
(43) Pub. Date: Feb. 26, 2026

(54) GEAR TRACKING AND REPORTING SYSTEM AND METHOD

(71) Applicants: Floyd Henderson, Antigo, WI (US); Kristie Henderson, Antigo, WI (US)

(72) Inventors: Floyd Henderson, Antigo, WI (US); Kristie Henderson, Antigo, WI (US)

(21) Appl. No.: 19/328,126

(22) Filed: Sep. 13, 2025

Related U.S. Application Data
(60) Provisional application No. 63/685,747, filed on Aug. 22, 2024.

(51) Int. Cl. G06Q 10/087; G06K 19/06

(52) U.S. Cl. CPC G06Q 10/0877; G06K 19/06; G06K 2019/06253

(57) ABSTRACT

A computerized communication device running an item tracking application comprising a CPU executing computer software instruction stored in an associated memory to create an item record to track an item. A computer server linked wirelessly with the computerized communication device wherein the computer server host a database comprising a plurality of item records. Each item record comprises a tag name for a tracking tag, an owner name, and owner contact information, and each item record further comprises a tag record encoded on the tracking tag.

### CROSS REFERENCE TO RELATED APPLICATIONS

This application claims benefit of U.S. Application 63/685,747 filed Aug. 22, 2024, which is incorporated herein in its entirety.

### FIELD OF INVENTION

The present invention relates to the field of registering items into a data base that can track belongings and be used to facilitate reporting a lost item found by another person.

### BACKGROUND

Each day, individuals across the globe misplace or leave behind items of importance. In many instances, the owner is never able to determine where the item was left and is therefore unable to return to find the item. Moreover, even if the item is found by another individual, there is often no way for the good Samaritan to locate the rightful owner to advise them of the found item.

Such a situation is increasingly common with sporting instruments, such as golf clubs, for example. In this regard, many golfers accidentally lose a club somewhere along the golf course and are not able to retrieve it.

Although there are existing devices such as electronic tracking tags which may be secured onto certain items, these devices are not suitable for use with sporting instruments such as golf clubs, as the bulky nature and delicate operation of the devices would interfere with the use of the instrument, thus making their presence a nuisance.

With the above factor in mind, the inventors of the present invention have created a novel system and method for allowing users to locate missing items and for allowing other users to report finding an item. As described below, the inventive system utilized technology that will not impede or otherwise interfere with the operation of the object to which they are attached, and thus represent a technological advancement that is not rendered obvious by any known art.

Based on the foregoing, there is a need facilitate reporting found lost items so the owner can reunite with their belongings.

### SUMMARY

The invention is an application operating on a smart phone implementing an item tracking program. The tracking application can create an item record in a database stored in a computer server. The smart phone can interact with a NFC/RFID tag using a read/write device associated with the phone to write or erase information recorded in the database onto the tag, and the tag can be created by the read/write device associated with the smart phone to encode the chip.

In an embodiment, a computerized communication device running an item tracking application comprising a CPU executing computer software instruction stored in an associated memory to create an item record to track an item. A computer server linked wirelessly with the computerized communication device wherein the computer server host a database comprising a plurality of item records. Each item record comprises a tag name for a tracking tag, an owner name, and owner contact information, and each item record further comprises a tag record encoded on the tracking tag.

In an embodiment, a method for operating a computerized communication device to run an item tracking application comprises providing a CPU executing computer software instruction stored in an associated memory to create an item record to track an item. Linking a computer server wirelessly with the computerized communication device wherein the computer server host a database comprising a plurality of item records. Creating each item record to comprise a tag name for a tracking tag, an owner name, and owner contact information. Each item record further comprises a tag record encoded on the tracking tag.

In an embodiment, a system for tracking an item comprises a computerized communication device with a CPU executing computer software instruction stored in an associated memory to create an item record to track an item. A computer server linked wirelessly with the computerized communication device hosts a database comprising a plurality of item records. Each item record comprises a tag name for a tracking tag, an owner name, and owner contact information, and each item record further comprises a tag record encoded on a NFC or a RFID embedded in the tracking tag.

### Advantages

1. Ease of use as the interactive control screen provide an intuitive environment for operating the tracking app.

2. A convenient method for encoding a NFC or RFID chip embedded in a tracking tag.

3. Ability to fully interact with the database and edit information in the database and the various tracking tags.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 depicts a mobile application Home Screen operating on a communication device, such as a smart phone, which interfaces and interacts with the database/server to input data on items to be tracked by the application, in an exemplary embodiment;

FIG. 1A depicts a mobile application Profile and More screen which interacts with the database/server, in an exemplary embodiment;

FIG. 2 depicts a Read Tag function on a display screen within the application, in an exemplary embodiment;

FIG. 3 depicts a Create Tag function within the application, in an exemplary embodiment;

FIG. 3A depicts a Save Record function operating on the application, in an exemplary embodiment;

FIG. 4 depicts a Write Tag function operating on the application, in an exemplary embodiment;

FIG. 4A depicts an Edit Tag function operating on the application, in an exemplary embodiment;

FIG. 5 depicts an Erase function within the application to implement an Erase Tag function and erase a NFC or RFID tag, in an exemplary embodiment;

FIG. 6 depicts an Erase function within the application to implement an Erase Record function to erase a record in the database, in an exemplary embodiment;

FIG. 6A depicts an Erase School Tags Record function within the application, in an exemplary embodiment;

FIG. 7 depicts an Erase All Records function within the application to erase all records in the database, in an exemplary embodiment;

FIG. 8 depicts a Home function identical to the one depicted in FIG. 1, in an exemplary embodiment;

FIG. 9 depicts a block diagram of an example operating environment in which the gear tracking and reporting system may be implemented, in an exemplary embodiment;

FIG. 10 depicts a schematic block diagram showing the internal components of a computer smartphone, laptop, desktop, or tablet (or similar computer/communication device), in exemplary embodiment.

### DETAILED DESCRIPTION OF PREFERRED EMBODIMENTS

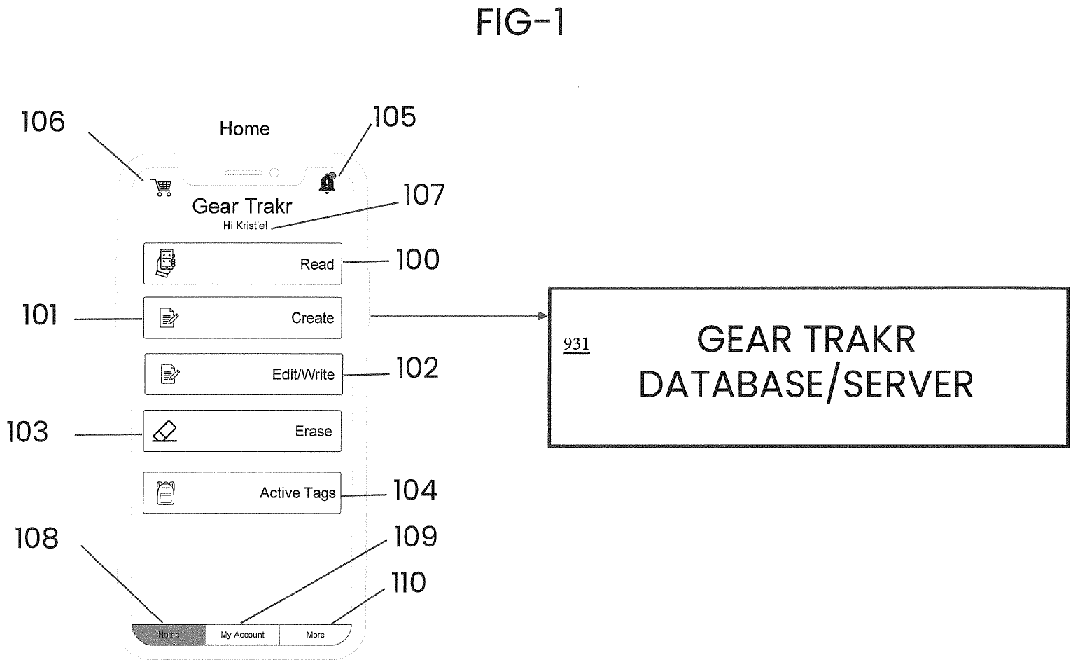

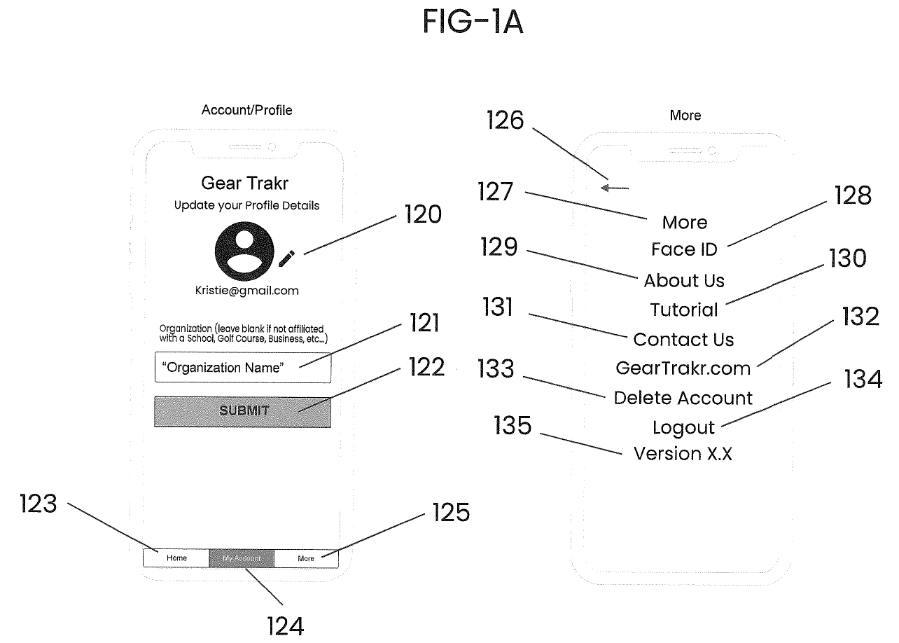

Preferred embodiments of the present invention and their advantages may be understood by referring to FIGS. 1-10, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors.” Several nonlimiting examples of connectors include, but are not limited to, thread-to-connect, twist-to-connect, and push-to-connect type devices, opposing strips of hook and loop material (e.g., Velcro®), attractively-oriented magnetic elements or magnetic and metallic elements, buckles, clamps, sockets, clips, carabiners, and compression fittings, for example.

Moreover, the term “permanently secured” shall be used to describe a situation wherein two or more objects are joined together in a manner so as to prevent the same objects from being separated. Several nonlimiting examples of permanent connectors include various adhesives such as glue or resin, hardware such as nuts and bolts, and welds, for example.

As described throughout this document, the term “protected object” and derivatives thereof can include any physical item to which a tracking tab device can be secured in order to allow the item to be tracked, reported, and/or found by a user.

The term “user” and derivatives thereof can include any person utilizing the system to track, report or find a protected object.

The term “site owner” can describe the individual or legal entity that is providing the various system, mobile application, and/or method steps for execution by users.

In the preferred embodiment, the present system and method can include a mobile device application (i.e., App) which can be loaded onto an electronic device such as a smartphone, for example. Of course, the inventive concepts disclosed herein are not to be construed as limiting to a smartphone, or a mobile application, as the system can utilize any type of instruction sets which can be executed on any type of processor enabled device that can be manipulated by a human operator.

In various embodiments, certain aspects of the method and system can be performed in any number of different manners, and can utilize any number of different websites, website URL's and/or computer networks. Additionally, it is contemplated that some of the functionality described herein can also be performed simultaneously via different websites that are directed towards different uses. For example, some embodiments can be directed specifically for use with a specific sport/sporting equipment such as golf, for example, whereas other embodiments may be directed specifically for use with sensitive scientific instruments, for example. Such functionality can be performed under the direct supervision of the original site owner, or via secondary site owners through a franchise, licensing or other type of arrangement.

The present invention will now be described in detail with reference to embodiments thereof as illustrated in the accompanying drawings.

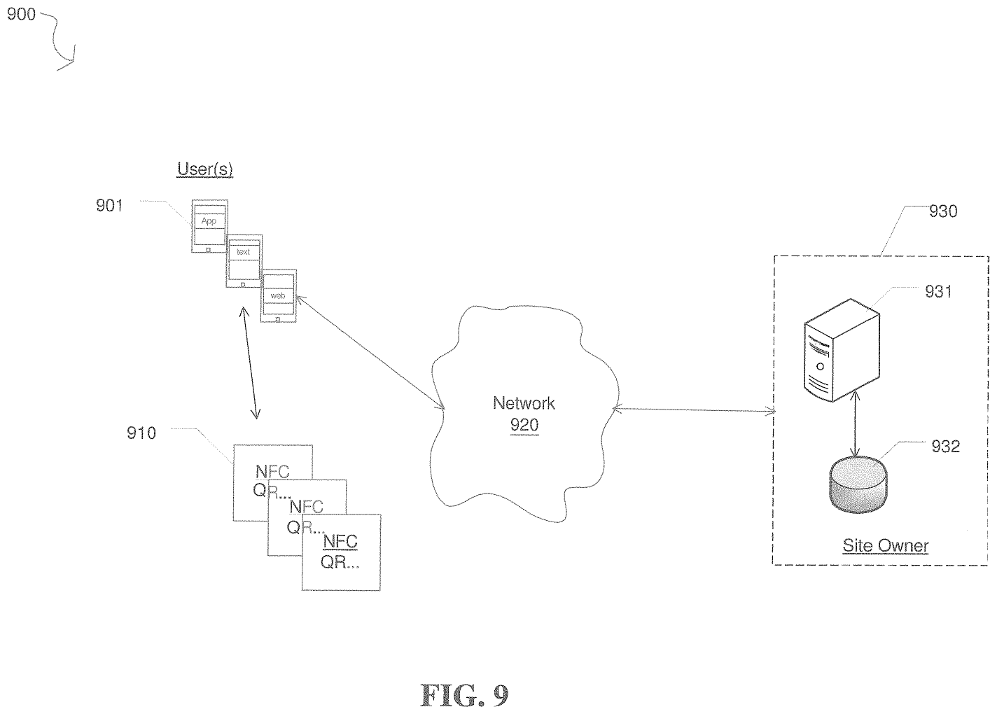

FIG. 9 is a block diagram of an example operating environment 900 in which the gear tracking and reporting system may be implemented. The operating environment 900 may include at least one user operating an interface device 900 running a mobile application, at least one tracking tab 910 that is in selective communication with one of the interface devices 901 used by a user, and a site owner platform 930 that are connected over a communication network 920.

As described herein, the site owner platform 930 can include any number of different computers 931, such as computer servers, application servers, workstations, and the like, which can interface with the mobile applications that are loaded onto the user interface devices 901. The site owner platform 930 can also include or be connected to any number of distinct databases 932 in memory. The application servers can function to provide operating instructions for the mobile App to execute. In this regard, the site owner can provide functionality for the interface device 901 to offer a menu of options, such as inputting information for a protected object by its owner and/or for reporting a found protected object.

The database 932 can store any type of information for allowing the system to operate in the intended manner. This includes a database of the various items registered by the gear tracking application (i.e., the mobile App).

In one embodiment, the user interface device 901 will preferably include a users' own smartphone or tablet device having an integrated processor, memory, and network access for running the mobile App. In the preferred embodiment, the device will include a camera capable of detecting the presence of a unique code such as a QR code or barcode, for example. Additionally, the device will preferably include a Near field Communication device (commonly referred to as an NFC reader) or an RFID reader capable of communicating with the tracking tab.

Of course, the system embodiments are not limited to the use of a smartphone or the use of a mobile Application, as any device capable of interfacing with the tracking tab and communicating with the site owner platform over the internet or other such network are contemplated, including desk tops, tablets, or laptops

In one embodiment, the tracking tab 910 can include, comprise, or consist of a relatively malleable substrate having a connector along one end for connecting the tab onto a protected object. In the preferred embodiment, the connector can comprise a permanent connector such as resin or adhesives; however, other types of connectors capable of permanently or removably attaching the tab to the object are also contemplated and can further include a RFID device.

In one embodiment, tracking tab 910 can include functionality for communicating with a user interface device. In this regard, the tracking tab can include one or more markings such as a barcode or QR code, for example, and can also include one or more electronic communication devices such as an NFC or RFID chip embedded in the tag 910, for example. Additionally, the tracking tab 910 may include any number of printed instructions so as to inform a user how to report finding the object to which the tab 910 is secured.

The network 920 can include any known communication means and the related technology such as, for example, a cellular network, a wide area network (WAN), a local area network (LAN), for example that can connect to the site owner server directly or over the internet.

In operation, the system can function to allow a user to obtain any number of different tracking tabs 910 and to secure the same onto any number of different objects. When so secured, the tabs 910 will be linked to the user profile of the device owner that is stored by the system database. In the event that another individual comes into possession of the protected object, the individual may utilize the instructions on the tracking tab to report finding the protected object. In some instances, the finding user may report finding the object by utilizing their smartphone to access the QR code, barcode, or NFC functionality of the tracking tab.

In some embodiments, this reporting action may include an identification of where the object was found, such as a description inputted by the finding user, or by allowing the system to retrieve the physical location of the finding users smartphone via the devices integrated location identification system (e.g., cellular or GPS tracking location). Additionally, the system may allow the finding user to input retrieval information for the device owner. This information may include, for example, a text box where the finding user may provide their contact telephone number or to leave a message (e.g., “I found your golf club, I will leave it at the pro shop at Pines Golf Course.”)

In either instance, upon receiving the report that the protected object has been found, the system will report the same to the user to whom the tag is registered, along with the information instructions for retrieving the same.

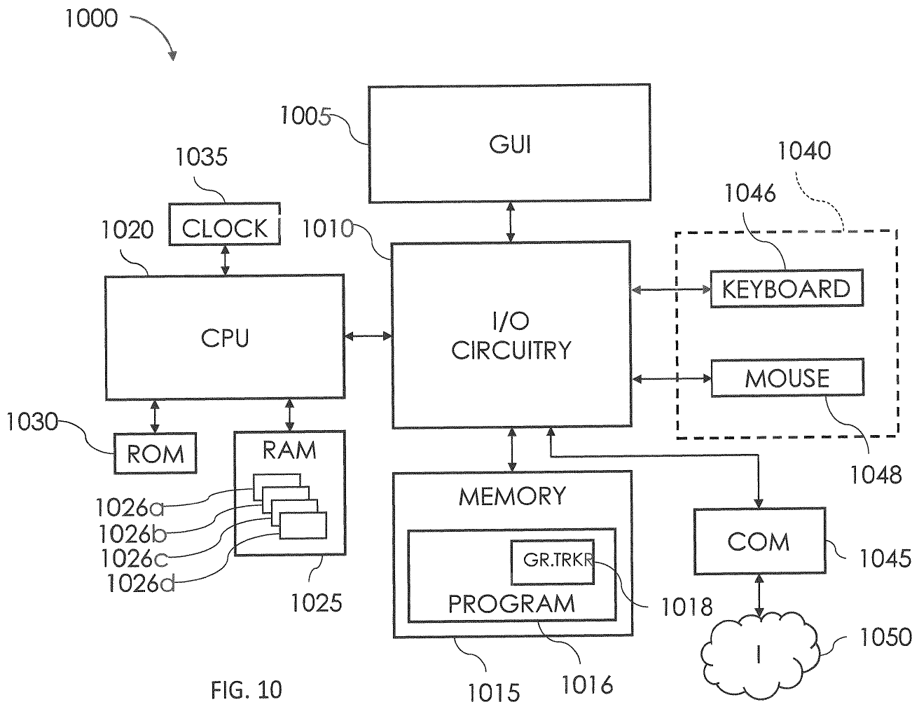

As depicted in FIG. 10, a schematic block diagram 1000 shows the internal components of a computer smartphone, laptop, desktop, or tablet (or similar computer/communication device) that can comprise a display 1005 comprising a touch sensitive screen functioning as a graphical user interface (GUI), input/output (I/O) circuitry 1010 for processing and routing input and output data, memory 1015 storing digital data, which can include computer programs (in the form of executable program code) 1016, including the Gear Tracker Software Module (GR,TRKR) 1018 or Application (App) of the invention, a central processing unit (CPU) 1020, with associated Random Access Memory (RAM) 1025 consisting of RAM modules 1026a, 1026b, 1027c, and 1026d, Read Only Memory (ROM) 1030, a clock 1035 regulating the function of the device, and external hardwire 1040 that may be attached, such as a keyboard 1046 or a mouse 1048, which also can serve as a GUI. However, typically touch inputs on the touch sensitive display/GUI 1005, which may also include virtual graphical analogues of the mouse 1048 and keyboard 1046. Finally, the device can include a communication module (CM) 1045 for accessing the Internet 1050 and transmitting or receiving data between the device and external data sources, such as a computer server hosting an Internet accessible website. CM 1045 can support communication over a cellular mobile network, WAN, WiFi, Bluetooth, or similar wireless connection to interface or communicate with other devices. Using these communication resources, CM 1045 can access and communicate over the Internet 1050 or use a short range wireless connection to a nearby device.

In operation, the CPU 1020 can access through I/O circuitry 1010 memory 1015 storing programs 1016 including the GR.TRKR 1018 of the invention. The CPU 1020 can execute the programs 1016 as well as processing any stored digital data in memory 1015. The CPU 1020 can also operate to process data received or transmitted via communication module 1045 using I/O circuitry 1010. The CPU 1020 can process received data from or transmitted to communication module 1045 as well as data manipulation inputs from the GUI screen 1005 of the tablet, smart phone, computer, or exterior hardware 1040 to use in execution of GR.TRKR 1018. The touch sensitive screen forming GUI 1005 can receive data inputs reflecting scrolling or swiping movements of a user's finger or other input, which the CPU 1020, utilizing executed programs from memory 1015, such as GR.TRKR 1018, to process data received from CM 1045 to display that data reflecting those scrolling and swiping inputs from a user on screen 1005.

FIG. 1 depicts a mobile application Home Screen operating on a communication device, such as a smart phone, which interfaces and interacts with the database/server 931 to input data on items to be tracked by the application. Users can perform functions 100, 101, 102, and 103 from this location within the app. This allows a user to communicate with the server to initiate the specified function on each button icon. Read function icon 100 can be used to scan a code on a tracking tag 910. Read function 100 reads the tracking tag 910 into the memory, which can comprise a barcode or QR code affixed to the item or embossed on tracking tag 910, for example, a plastic tracking tag, and can also include one or more electronic communication devices such as an NFC or RFID tag. Create function 101 initiates creation of the data entry into the data base stored in the server memory corresponding to an active tracking tag 910. Edit/Write function 102 allows the actual data entries for the created tag data stored in database 932 or any editing, while Erase function 103 can erase the current entry from database 932. Active Tags function 104 allows users to see all active tracking tags 910 created within the server for mass activation or item-by-item activation or selected activation. Alarm icon 105 can indicate that the user has notifications available for their tracking tags 910 such as when one is found. Shopping cart icon 106 interacts with the website store for purchase of products. User Display icon 107 can display a user name. Home function icon 108 will return the display to the home page. My Account icon 109 can access and open an account window providing current details of the user's account. The More icon 110 can open and access additional screens within the application.

FIG. 1A depicts a mobile application Profile and More screen which interacts with the database/server 931. Edit picture icon 120 allows users to change a profile picture, and can edit an organization name or user name by entering the information in using Edit icon 121. The Submit icon 122 can submit the edit data to the database/server 931. Home icon 123 can return the display to the home page as depicted in FIG. 1. The My Account icon 124 can provide access to the My Account page, and the More icon 125 can link to the More page for additional features via found on Screen 126. The More icon 127 can switch to a “next page” to provide additional pages choices. The Face ID icon 128 can access a biometric page to verify a user's identity. The About Us icon 129 can access an information page to provide updated information on the gear tracking company operating the network 900. The Tutorial icon 130 can access a tutorial information page offering a plurality of links to explain how the operating system operates and how to interact with and use the App. The Contact Us icon 131 can link to an information page for the company including department phone numbers, customer service info, email addresses, physical address information, and links to Internet hosted websites. GearTrakr.com icon 132 can link directly to a company Internet website. Delete Account icon 133 can enable a function to immediately delete a Gear Tracker account. Logout icon 134 can provide an immediate logout option to logout from the app and terminate the Internet connection to the system 900. Version icon 135 can provide the version installed and operating and even if an update is available.

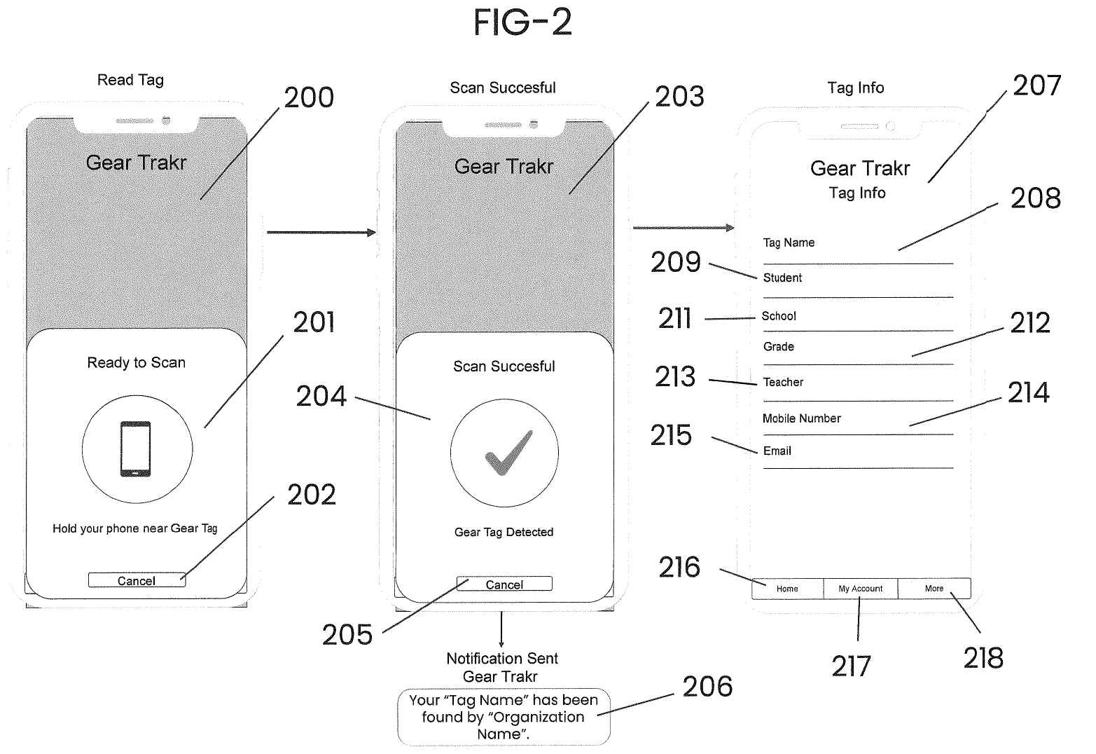

FIG. 2 depicts an embodiment of a Read Tag 200 function on a display screen within the application. Ready to Scan screen 201 depicts a Ready to Scan function that can interact with an exemplary NFC tracking tag 910 to read the information encoded on the tag. By holding the NFC tracking tag 910 close to the phone when advised via the application, screen 203 can appear to with Scan Success icon 204 indicating a successful scan of NFC tracking tag 910. If successful in reading the NFC tracking tag 910, notification message 206 will automatically transmit. This is an instant notification sent by Gear Trkr to the owner of the NFC tracking tag 910, and in an embodiment can read as “Your ‘Tag Name’ has been found by ‘Organization Name” Cancel icon 205 can abort this process and cancel the function.

The display screen 203 can then advance to a Tag Info Screen 207 that displays database information on the item associated with NFC Tag 910. In an exemplary embodiment, this can comprise data fields such as Tag Name field 208, a Student (or Owner Name) field 209, a School field 211, a Grade field 212, a Teacher field 213, a contact Mobile Number data 214, or an Email field 215. The finder of a tracking tag 910 can then contact the registered owner of the tag via Mobile Number 214 and/or Email 215. The function icons 216, 217, and 218 can provide the same function as described above.

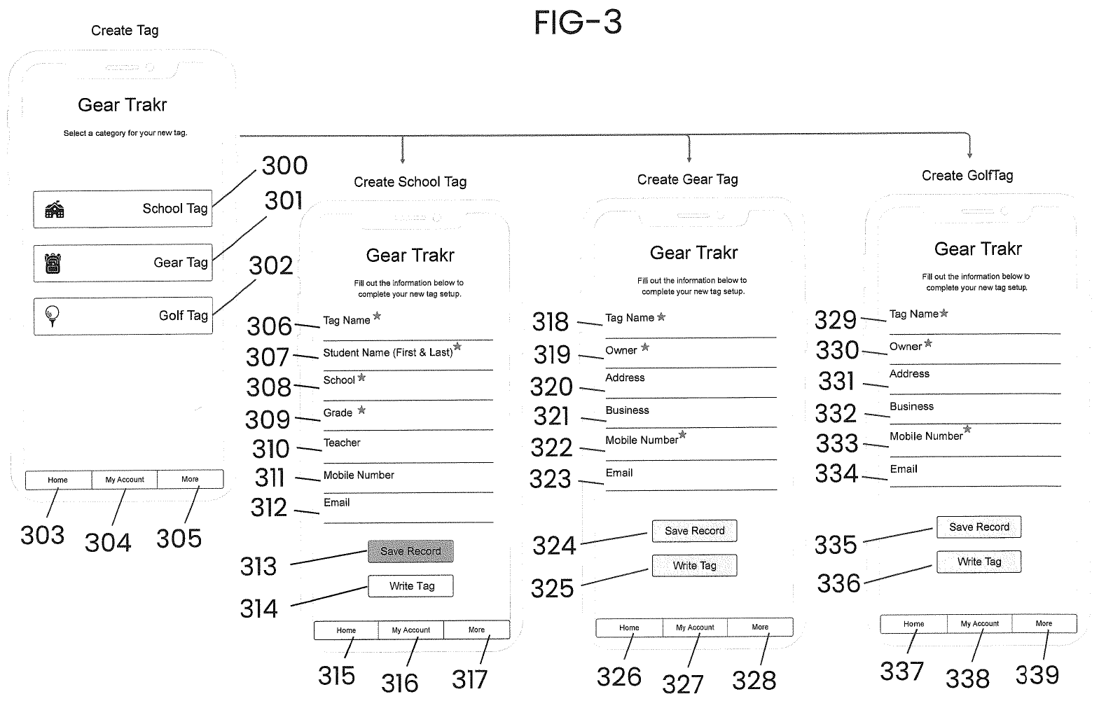

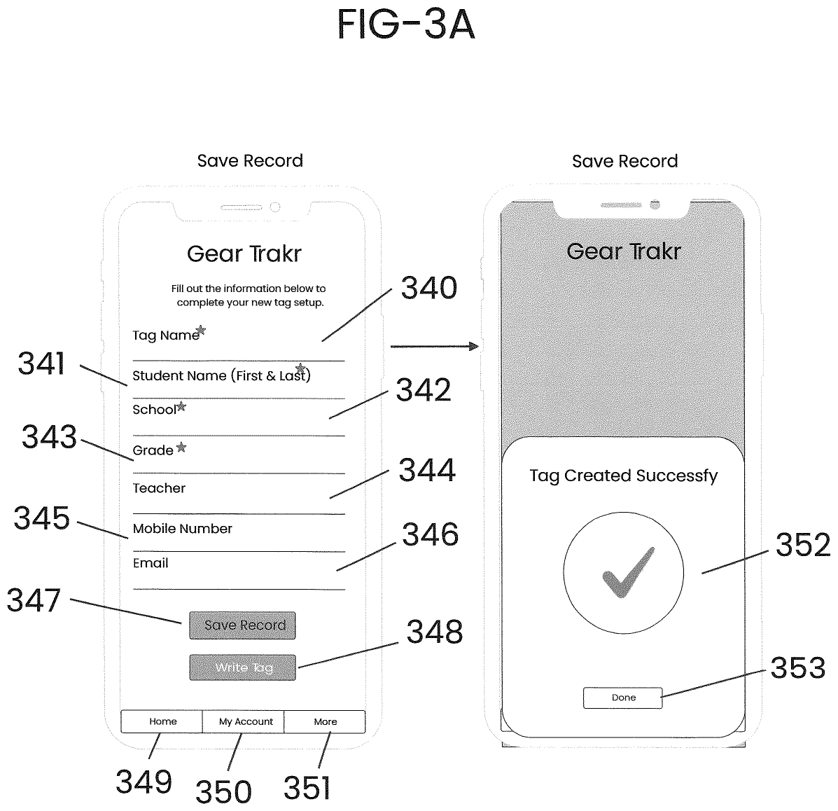

FIG. 3 is an exemplary the Create Tag function within the Gear Trkr app. Icon items 300, 301, and 302 are the type of tags each user can create. Create School Tag icon 300 can open an interactive Create School Tag screen which the user can use to enter identifying information. In this exemplary embodiment, a user can input a Tag Name 306, a Student Name 307, a School 308, a Grade 309, a Teacher 310, a Mobile Number 311, and an Email 312. Once a user enters this information, Save Record icon 313 can save this data to the Gear Trakr server 931. The user can then click on Write Tag icon 314, hold the tracking tag 910 near the cell phone/device, and the application will write that information to the chosen tracking tag 910.

Create Gear Tag icon 301 can open an interactive Create Gear Tag function into which the user can input identifying information they choose. In an exemplary embodiment, this can comprise a Tag Name 318, an Owner 319, an Address 320, a Business 321, a Mobile Number 322, and an Email 323. Once a user enters this information, Save Record icon 324 can be used to save the data in the Gear Trakr server 931. The user can then click on Write Tag icon 325, hold the tracking tag 910 near the cell phone/device and the application will write that information to the chosen tracking tag 910.

Create Golf Tag 302 can open an interactive Create Golf Tag function which the user can enter the identifying information they choose. In an exemplary embodiment, this can comprise a Tag Name 329, an Owner 330, an Address 331, a Business 332, a Mobile Number 333, and an Email 324. Once a user enters this information, Save Record icon 335 can be used to save the data in the Gear Trakr server 931. The user can then click on Write Tag icon 336, hold the tracking tag 910 near the cell phone/device and the application can write that information to the chosen tracking tag 910.

The function icons 315, 316, 317, 326, 327, 328, 337, 338, and 339 can provide the same function as described above.

FIG. 3A depicts an embodiment of a Save Record function operating on the Gear Trakr application. Selecting Save Record icon 347 can save the displayed information entered on the screen in items 340, 341, 342, 343, 344, 345, 346. This information can comprise Tag Name 340, Student Name 341, School 342, Grade 343, Teacher 344, Mobile Number 345, and Email 346, Save Record icon 347 can save the information to the server 931, while Write Tag icon 348 can write that information to the chosen tracking tag 910 when the phone/device is held close to the chosen tracking tag 910.

Tag Created Successfully icon 352 can confirm the record was saved successfully, and Done icon 353 can close out the function. Icons 349, 350, and 351 can function as described above.

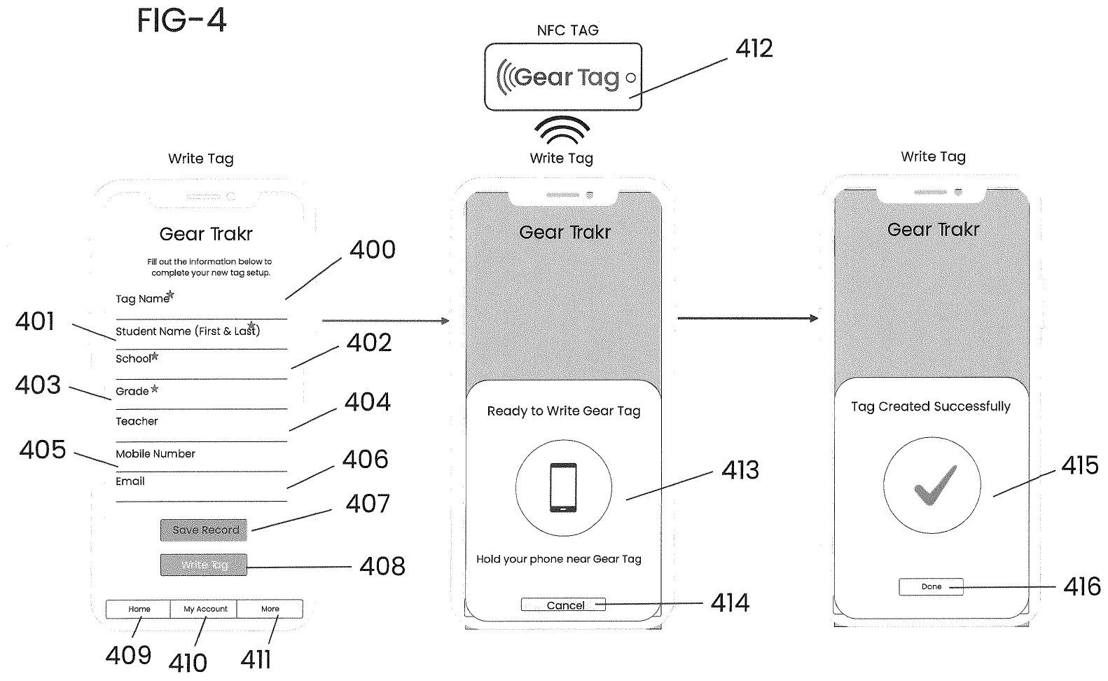

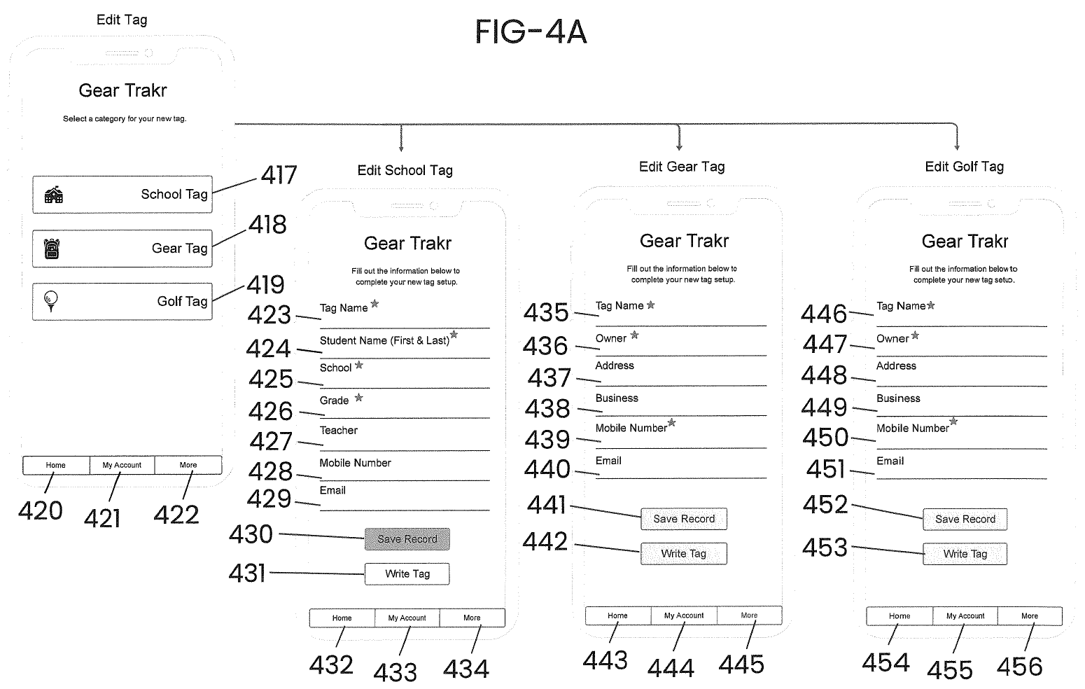

FIG. 4 depicts a Write Tag function operating on the application. On the Write Tag screen the user can enter their chosen information in items 400, 401, 402, 403, 404, 405, 406 and click 407 to save the record to the database. The data fields can comprise Tag Name 401, Student Name 402, Grade 403, Teacher 404, Mobile Number 405, and Email 406. Save Record icon 407 can save the information to the server 931, while Write Tag icon 408 can write that information to the chosen NFC tag 412 when the phone/device is held close to the chosen NFC tag 412.

The Ready to Write Gear Tag status screen status can indicate status for the Ready to Write Gear Tag function 413 with an instruction reading “Hold your phone near Gear Tag.” Cancel icon 414 can cancel the entire process. The Tag Created Successfully screen 415 can indicate a successful Write Tag operation to the NFC tag 412, and Done icon 416 can end the function. Icons 409, 410, and 411 can function as described above.

FIG. 4A depicts an Edit Tag function operating on the application. Item 417, 418, 419 can all be edited here. Edit School Tag icon 417 can open an interactive Edit School Tag screen which a user can enter and edit information they choose in items 423, 424, 425, 426, 427, 428, 429. In this exemplary embodiment, a user can open and enter and edit a Tag Name 423, a Student Name 425, a School 425, a Grade 426, a Teacher 427, a Mobile Number 428, and an Email 429. Once a user enters this information, Save Record icon 430 can save this data to the Gear Trakr server 931. The user can then click on Write Tag icon 431, hold the tracking tag 910 near the cell phone/device, and the application will write that information to the chosen tracking tag 910.

Edit Gear Tag icon 418 can open an interactive Edit Gear Tag function into which the user can enter and edit identifying information they choose. In an exemplary embodiment, this can comprise a Tag Name 435, an Owner 436, an Address 437, a Business 438, a Mobile Number 439, and an Email 440. Once a user enters this information, Save Record icon 441 can be used to save the data in the Gear Trakr server 931. The user can then click on Write Tag icon 441, hold the tracking tag 910 near the cell phone/device and the application will write that information to the chosen tracking tag 910.

Edit Golf Tag 419 can open an interactive Create Golf Tag function which the user can enter and edit the identifying information they choose. In an exemplary embodiment, this can comprise a Tag Name 446, an Owner 447, an Address 448, a Business 449, a Mobile Number 450, and an Email 451. Once a user enters this information, Save Record icon 452 can be used to save the data in the Gear Trakr server 931. The user can then click on Write Tag icon 453, hold the tracking tag 910 near the cell phone/device and the application can write that information to the chosen tracking tag 910. The function icons 420, 421, 422, 432, 434, 435, 443, 444, 445, 454, 455, and 456 can provide the same function as described above.

Once this information is filled out, Save Record icon 430 can save the information. The user can then click on Write Tag 431, hold the tracking tag 910 near the cell phone/device and the application will write that information to the chosen tracking tag. Gear Tag icon 418 will take you to the Edit Gear Tag screen where user can enter the identifying information they choose. Once this information is filled out, Save Record icon 441 will save the information. The user can then click on Write Tag 442, hold the tracking tag near the cell phone/device and the application will write that information to the chosen tracking tag. Golf Tag 419 will open an Edit Golf Tag screen where the user can enter the identifying information they choose. Once this information is filled out, Save Record icon 452 can saved the information. The user can then click on Write Tag 453, hold the tag near the cell phone/device and the application will write that information to the chosen tracking tag 910.

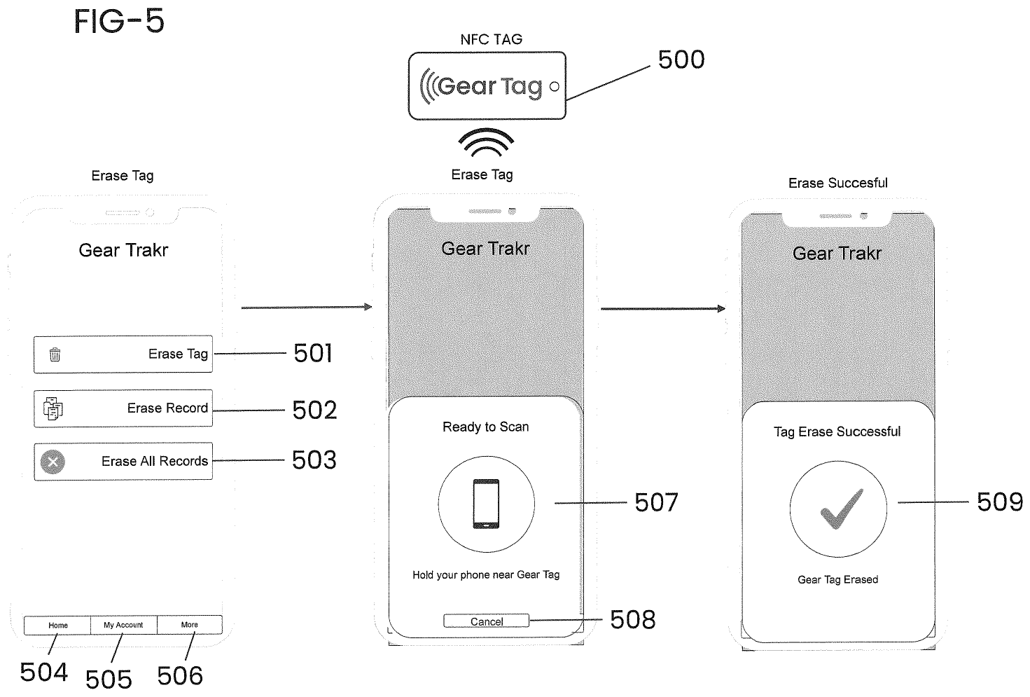

FIG. 5 depicts an Erase function within the application to implement an Erase Tag function and erase a NFC Tag 500. Erase Tag icon 501 can access an Erase Tag screen advance to a Ready to Scan icon 507 which can advise user to hold Tag 500 near the device to erase the information on the tracking tag. Cancel icon 508 can abort the process. In the Success screen 509 can indicate that the tracking tag 500 was erased successfully. Erase Record icon 502 can open a similar screen to erase a record, and Erase All Records can open a screen to erase all records. Home icon 504, My Account 505 icon, and More icon 506 as described above.

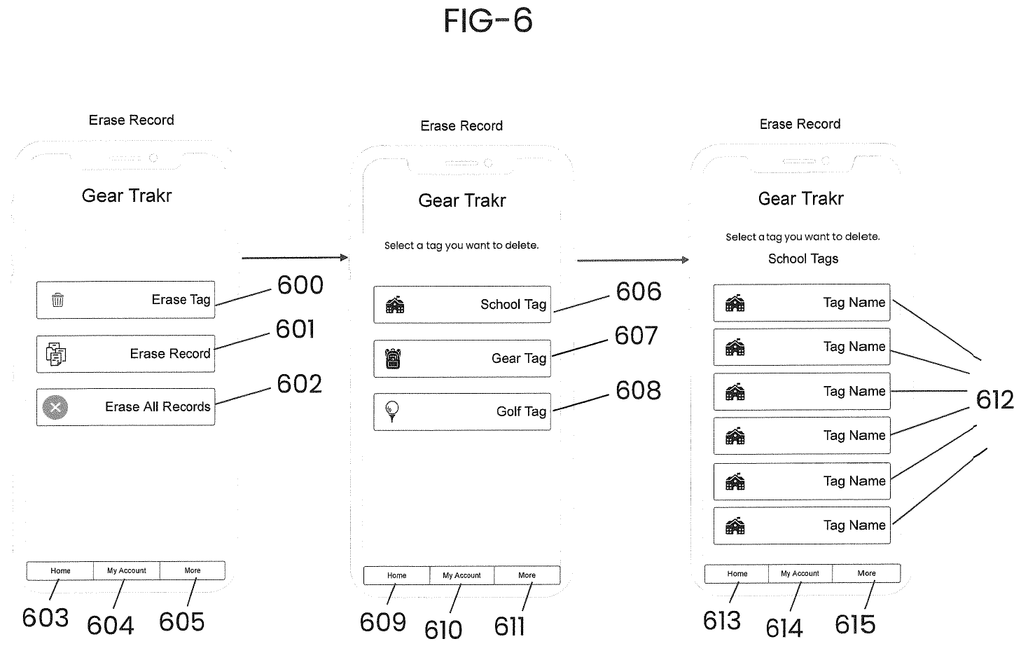

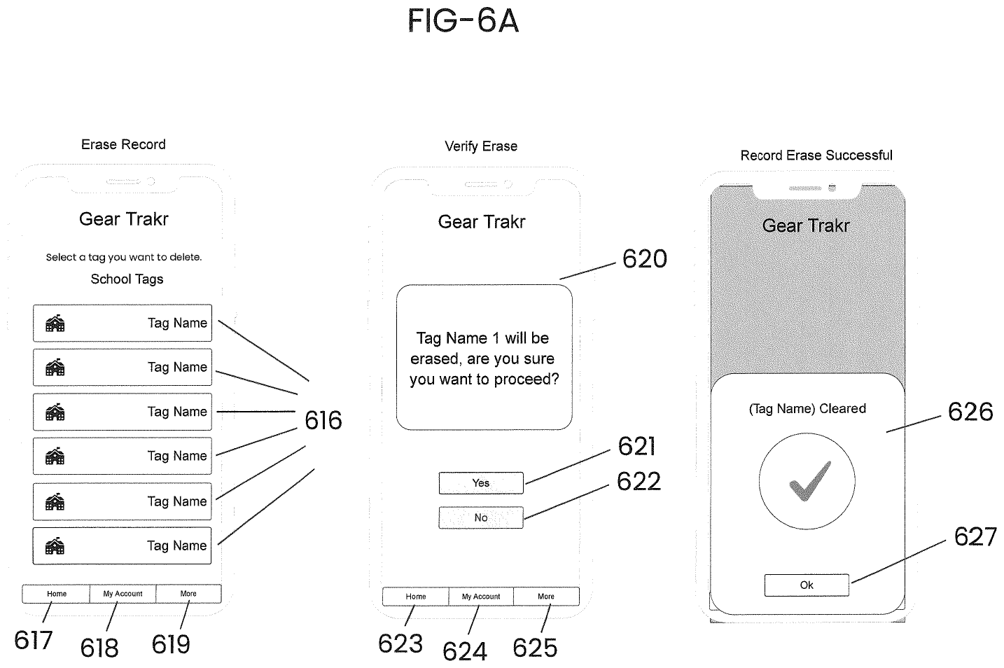

FIG. 6 depicts an Erase function within the application to implement an Erase Record function to erase a record in the database. Erase Record icon 601 can open an Erase Record screen comprising School Tag icon 606, Gear Tag icon 607, and Golf Tag 608. Selecting School Tag icon 606 can open a Erase Record School Record screen. This Erase Record School Record screen can comprise a list of a plurality of Tag Name icons 612 stored in memory which can be selected to erase the selected record(s) named. Erase Tag 600 can open the Erase Tag screen, and Erase All Records icon 602 can open the Erase All Records screen. Gear Tag icon 607 can open a can open a list of Gear Tag records, and Golf Tag icon 608 can open a list of Golf Tag records. The Home icons 603, 609, 613, My Account icons 604, 610, 615, and More icons 606, 611, 614 function identically as described above.

FIG. 6A depicts an Erase School Tags Record function within the application. The Erase School Tags Record screen provides a list of available user tags stored as School Tags. Tag Name icons 616 can be selected to delete the associated record in turn. The Verify Erase screen can comprise a verification notice icon 620 that can include a notification reading, for example, “Tag Name I will be erased. Are you sure you want to proceed?” Selecting Yes icon 621 or No 622 icon will respectively proceed or abort the Erase School Tags Record process. The Erase Successful screen can comprise a [Tag Name] Cleared icon 626 and a OK icon 627 to acknowledge completion of the function. The Home icons 617, 623, My Account icons 618, 624, and More icons 619, 625 function identically as described above.

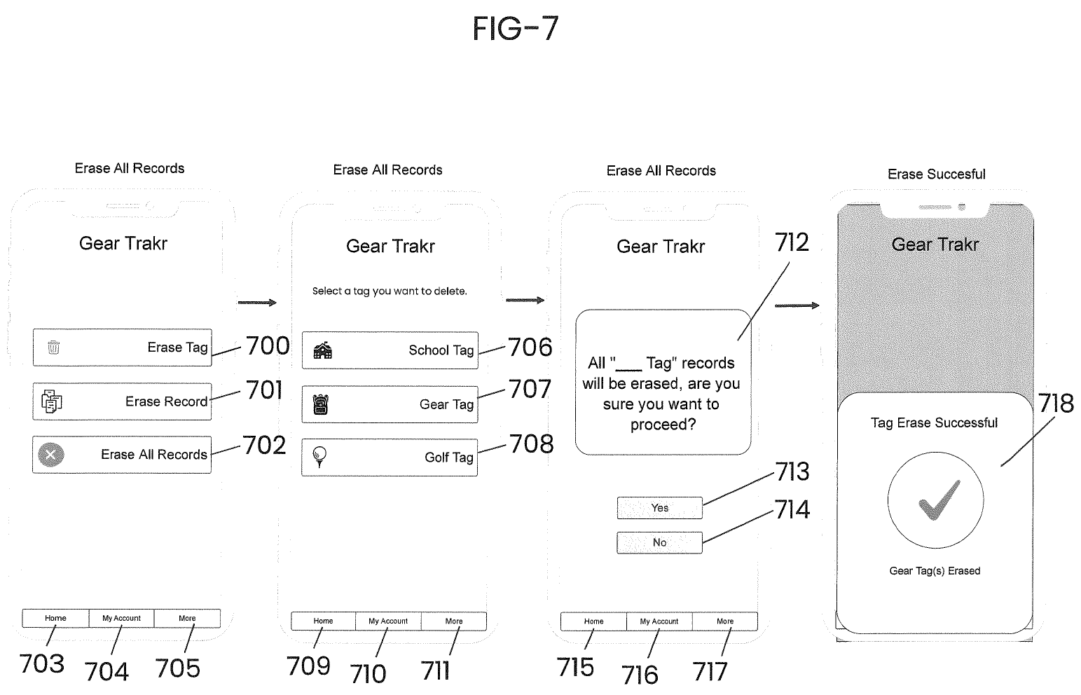

FIG. 7 depicts an Erase All Records function within the application function to erase all records in the database. The Erase screen can comprise Erase Tag icon 700, Erase Tag icon 701, and Erase All Records icon 702. Erase All Records icon 702 can open an Erase All Records screen comprising School Tag icon 706, Gear Tag icon 707, and Golf Tag 708. Selecting any of these icons 706, 707, and 708 can open an Erase All Records screen. This Erase All Records screen can comprise warning and notification text reading, for example, “[a]ll ‘Tag’ records will be erased. Are you sure you want to proceed?” Selecting Yes icon 713 or No 714 icon will respectively proceed and execute the Erase All Records function or abort the Erase All Records process. The Erase Successful screen can comprise a Tag Erase Successful icon 718 The Home icons 703, 709, 715, My Account icons 704, 710, 716, and More icons 705, 711, 717 function identically as described above.

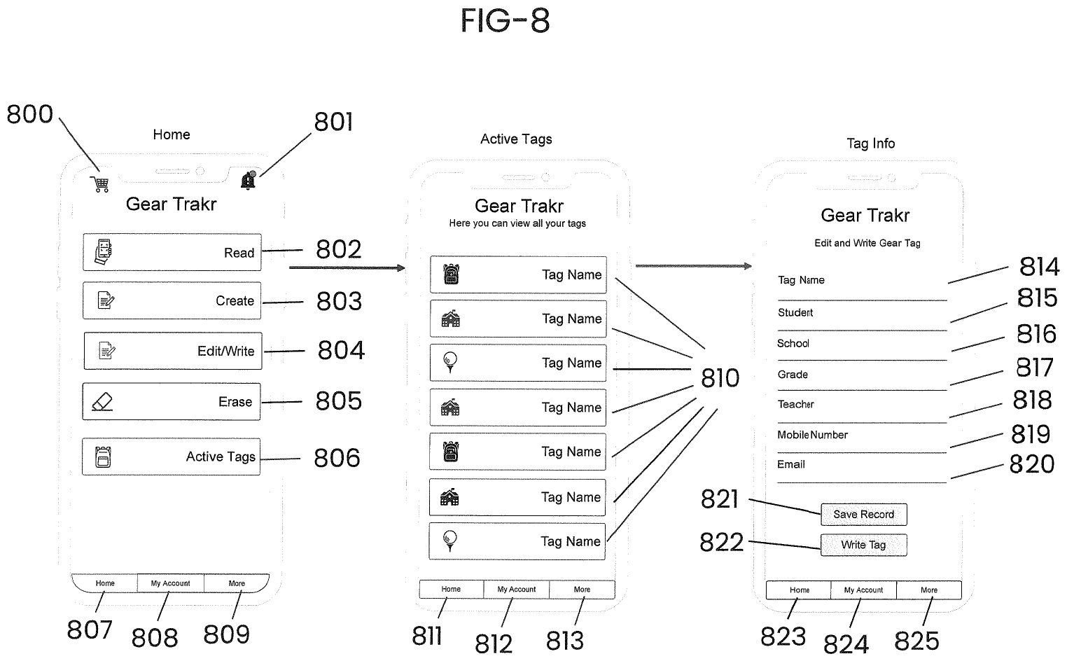

FIG. 8 depicts an embodiment of a Home function identical to the one depicted in FIG. 1. Users can perform functions 802, 803, 804, 805, and 806 from this location within the app. This allows a user to communicate with the server to initiate the specified function on each button icon. Read function icon 802 can be used to scan a code on a tracking tag 910. Read function 802 reads the tracking tag 910 into the memory, which can comprise a barcode or QR code affixed to the item or embossed on a tracking tag 910, for example, a plastic tracking tag, and can also include one or more electronic communication devices such as an NFC or RFID tracking tag. Create function 803 initiates creation of the data entry into the data base stored in the server memory corresponding to an active tracking tag 910. Edit/Write function 804 allows the actual data entries for the created tracking tag data stored in database 932 or any editing, while Erase function 805 can erase the current entry from database 932. Active Tags function 806 allows users to see all active tracking tags 910 created within the server for mass activation or item-by-item activation or selected activation. Alarm icon 801 can indicate that the user has notifications available for their tracking tags 910 such as when one is found. Shopping cart icon 800 interacts with the website store for purchase of products. Home function icon 807 can return the display to the home page. My Account icon 808 can access and open an account window providing current details of the user's account. The More icon 809 can open and access additional screens within the application.

Active Tags icon 806 can open an Active Tag function screen, which can comprise a list of Tag Name icons 810 associated with tag data stored in Gear Trakr Database/server 931. Using these Tag Name icons 810, a user can access the data of the stored tags. Home function icon 811 can return the display to the home page. My Account icon 812 can access and open an account window providing current details of the user's account. The More icon 813 can open and access additional screens within the application.

Each of the Tag Name icons 810 can open a Tag Info screen. The Tag Info screen can display database information on the item associated with tracking NFC Tag 910 stored in the Gear Trakr Database/server 931. In this exemplary embodiment, a Edit and Write Gear Tag screen and function can be accessed. In an exemplary embodiment, this can comprise editable data fields such as Tag Name field 814, a Student (or Owner Name) field 815, a School (or Business) field 816, a Grade field 817, a Teacher field 818, a contact Mobile Number data 819, or an Email field 820. The finder of a tracking tag 910 can then contact the registered owner of the tag via data entry 819 and/or 820. Save Record icon 821 can save the information, and the Write Tag 822 can write the data to a tracking tag 910. Home function icon 823 can return the display to the home page. My Account icon 824 can access and open an account window providing current details of the user's account. The More icon 825 can open and access additional screens within the application.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a patient movement monitoring and feedback system that are given for illustration and not for limitation and uses. Thus, the inventions are limited only by the appended claims. Although the inventions have been described in accordance with the embodiments shown, one of ordinary skill in the art can readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventors may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventors. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventors contemplate the various aspects in any number of claim forms. Accordingly, the inventors reserve the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

I claim:

1. A computerized communication device running an item tracking application, comprising:
a CPU executing computer software instruction stored in an associated memory to create an item record to track an item;
a computer server linked wirelessly with the computerized communication device wherein the computer server host a database comprising a plurality of item records;
each item record comprises a tag name for a tracking tag, an owner name, and owner contact information; and
each item record further comprises a tag record encoded on the tracking tag.

2. The computerized communication device running an item tracking application of claim 1, further comprising:
the tracking tag comprises a NFC or RFID chip embedded in the tracking tag.

3. The computerized communication device running an item tracking application of claim 1, further comprising:
the computerized communication device includes a NFC and RFID device for communicating with the NFC and RFID chip in the tracking tag to read and write information from and to the tracking tag.

4. The computerized communication device running an item tracking application of claim 1, further comprising:
the application includes a plurality of interactive display screens to control the application.

5. The computerized communication device running an item tracking application of claim 4, further comprising:
the display screen displaying at least one of a home screen, a read screen, a scan successful, a tag info screen, a create tag screen, a save screen, a write tag screen, an edit tag screen, an erase tag, an erase record screen, an erase all records screen, an active tag screen, and a tag info screen.

6. The computerized communication device running an item tracking application of claim 1, further comprising:
the encoded tracking tag comprises a plastic with item information embossed on the tracking tag that includes a tag name, an owner name, and an owner contact information.

7. The computerized communication device running an item tracking application of claim 3, further comprising:
the encoded tracking tag comprises a plastic with item information encoded in the tracking tag chip that includes a tag name, an owner name, and an owner contact information.

8. A method for operating a computerized communication device to run an item tracking application, comprising:
providing a CPU executing computer software instruction stored in an associated memory to create an item record to track an item;
linking a computer server wirelessly with the computerized communication device wherein the computer server host a database comprising a plurality of item records;
creating each item record to comprise a tag name for a tracking tag, an owner name, and owner contact information; and
each item record further comprises a tag record encoded on the tracking tag.

9. The method for operating a computerized communication device to run an item tracking application of claim 8, wherein the tracking tag comprises a NFC or RFID chip embedded in the tracking tag.

10. The method for operating a computerized communication device to run an item tracking application of claim 9, wherein the computerized communication device includes a NFC and RFID device for communicating with the NFC and RFID chip in the tracking tag to read and write information from and to the tracking tag.

11. The method for operating a computerized communication device to run an item tracking application of claim 8, wherein the application includes a plurality of interactive display screens to control the application.

12. The method for operating a computerized communication device to run an item tracking application of claim 11, wherein the display screen displays at least one of a home screen, a read screen, a scan successful, a tag info screen, a create tag screen, a save screen, a write tag screen, an edit tag screen, an erase tag screen, an erase record screen, an erase all records screen, an active tag screen, and a tag info screen.

13. The method for operating a computerized communication device to run an item tracking application of claim 8, wherein the tracking tag comprises a plastic with item information embossed on the tracking tag that includes a tag name, an owner name, and an owner contact information.

14. The computerized communication device running an item tracking application of claim 11, further wherein the tracking tag comprises a plastic with item information encoded in the tracking tag chip that includes a tag name, an owner name, and an owner contact information.

15. A system for tracking an item, comprising:
a computerized communication device with a CPU executing computer software instruction stored in an associated memory to create an item record to track an item;
a computer server linked wirelessly with the computerized communication device hosting a database comprising a plurality of item records;
wherein each item record comprises a tag name for a tracking tag, an owner name, and owner contact information; and
wherein each item record further comprises a tag record encoded on a NFC or a RFID embedded in the tracking tag.

16. The system for tracking an item of claim 15, wherein the computerized communication device includes a NFC and RFID device for communicating with the NFC and RFID chip in the tracking tag to read and write information from and to the tracking tag.

17. The system for tracking an item of claim 15, wherein the application includes a plurality of interactive display screens to control the application.

18. The computerized communication device running an item tracking application of claim 17, wherein the display screen displaying at least one of a home screen, a read screen, a scan successful, a tag info screen, a create tag screen, a save screen, a write tag screen, an edit tag screen, an erase tag, an erase record screen, an erase all records screen, an active tag screen, and a tag info screen.

19. The system for tracking an item of claim 15, wherein the encoded tracking tag comprises a plastic with item information embossed on the tracking tag that includes a tag name, an owner name, and an owner contact information.

20. The computerized communication device running an item tracking application of claim 16, wherein the encoded tracking tag comprises a plastic with item information encoded in the tracking tag chip that includes a tag name, an owner name, and an owner contact information.
